(19) United States
(12) Patent Application Publication
(10) Pub. No.: US 2008/0118841 A1
(43) Pub. Date: May 22, 2008

(54) NEGATIVE ACTIVE MATERIAL FOR RECHARGEABLE LITHIUM BATTERY, METHOD OF PREPARING THE SAME, AND RECHARGEABLE LITHIUM BATTERY INCLUDING THE SAME

(76) Inventors: Joon-Sup Kim, Yongin-si (KR); Sung-Soo Kim, Yongin-si (KR); Jea-Woan Lee, Yongin-si (KR); Sang-Jin Kim, Yongin-si (KR)

Correspondence Address: CHRISTIE, PARKER & HALE, LLP, PO BOX 7068, PASADENA, CA, 91109-7068, US

(21) Appl. No.: 11/937,462

(22) Filed: Nov. 8, 2007

(30) Foreign Application Priority Data
Nov. 20, 2006 (KR) 10-2006-0114515

(51) Int. Cl. H01M 4/58; H01M 10/00

(52) U.S. Cl. 429/231.95; 429/218.1

(57) ABSTRACT

Negative active materials for rechargeable lithium batteries are provided. The negative active materials include secondary particles including assemblies of primary particles. The primary particles include a compound represented by the formula, LiₓM_{y}V_{z}O_{2+d}, wherein 0.1≦x≦2.5, 0≦y≦0.5, 0.5≦z≦1.5, 0≦d≦0.5, and M is a metal selected from Al, Cr, Mo, Ti, W, Zr, and combinations thereof. The negative active materials for rechargeable lithium batteries provide rechargeable lithium batteries with excellent cycle-life characteristics.

### CROSS-REFERENCE TO RELATED APPLICATION

This application claims priority to and the benefit of Korean Patent Application No. 10-2006-0114515 filed in the Korean Intellectual Property Office on Nov. 20, 2006, the entire content of which is incorporated herein by reference.

### BACKGROUND OF THE INVENTION

1. Field of the Invention

The present invention relates to negative active materials for rechargeable lithium batteries, methods of preparing the same, and rechargeable lithium batteries including the same.

2. Description of the Related Art

Rechargeable lithium batteries have recently drawn attention as power sources for small, portable electronic devices. These batteries use organic electrolyte solutions and therefore have twice the discharge voltages of conventional batteries using alkaline aqueous solutions. Accordingly, lithium rechargeable batteries have high energy densities.

Lithium-transition element composite oxides capable of intercalating lithium, such as LiCoO₂, LiMn₂O₄, LiNiO₂, LiNi₁₋ₓCoₓO₂ (0<x<1), LiMnO₂, and so on, have been researched for use as positive active materials of lithium rechargeable batteries.

Various carbon-based materials, such as artificial and natural graphite and hard carbon, all of which can intercalate and deintercalate lithium ions, have been used as negative active materials. Of the carbon-based materials, graphite increases battery discharge voltages and energy densities because it has a low discharge potential of −0.2V compared to lithium. Batteries using graphite as the negative active material have high average discharge potentials of 3.6V and excellent energy densities. Furthermore, graphite is the most comprehensively used of the aforementioned carbon-based materials because graphite imparts better battery cycle life due to its outstanding reversibility. However, when used as negative active materials, graphite active materials have low densities and consequently low capacity in terms of energy density per unit volume. Further, there is some danger of explosion or combustion when a battery is misused, overcharged, or the like, because graphite is likely to react with the organic electrolyte at high discharge voltages.

To address these concerns, research has recently been conducted into oxide negative electrodes. For example, amorphous tin oxide has a high capacity per weight (800 mAh/g). However, this oxide has resulted in some critical defects such as a high initial irreversible capacity of up to 50%. Furthermore, part of the tin oxide tends to reduce into tin during the charge or discharge reaction, rendering it disadvantageous for use in a battery.

In another oxide negative electrode, LiₐMg_{b}VO_{c} (where 0.05≦a≦3, 0.12≦b≦2, 2≦2c−a−2b≦5) is used as the negative active material. Another lithium secondary battery includes a Li_{1.1}V_{0.9}O₂ negative active material. However, such oxide negative electrodes do not impart sufficient battery performance and therefore further research into oxide negative materials has been conducted.

### SUMMARY OF THE INVENTION

One embodiment of the present invention provides a negative active material for a rechargeable lithium battery that imparts excellent battery cycle-life characteristics. Another embodiment of the present invention provides a method of preparing the negative active material.

Yet another embodiment of the present invention provides a negative electrode and a rechargeable lithium battery including the negative active material.

According to one embodiment of the present invention, a negative active material for a rechargeable lithium battery includes secondary particles formed by assembly of primary particles. The primary particles include a compound of the following Formula 1.

LiₓM_{y}V_{z}O_{2+d} Chemical Formula 1

In Formula 1, 0.1≦x≦2.5, 0≦y≦0.5, 0.5≦z≦1.5, 0≦d≦0.5, and M is a metal selected from Al, Cr, Mo, Ti, W, Zr, and combinations thereof. According to one embodiment, M is either Mo or W.

According to one embodiment, the primary particles have an average particle diameter ranging from about 0.1 to about 10 μm. The primary particles may have a layered structure.

In another embodiment, the secondary particles have an average particle diameter ranging from about 2 to about 50 μm.

According to another embodiment of the present invention, a method of preparing a negative active material for a rechargeable lithium battery includes forming a composition by dissolving a vanadium source material, a lithium source material, and an M source material in a solvent. The method further includes adding a chelating agent to the composition to prepare a gel, drying the gel to prepare an organic-inorganic precursor, and subjecting the precursor to heat treatment.

The vanadium source material may be selected from vanadium metal, VO, V₂O₃, V₂O₄, V₂O₅, V₄O₇, VOSO₄.H₂O, NH₄VO₃, and mixtures thereof.

The lithium source material may be selected from lithium carbonates, lithium hydroxides, lithium nitrates, lithium acetates, and mixtures thereof.

The M source material may be selected from M-containing oxides, M-containing hydroxides, and mixtures thereof. In one embodiment, for example, M may be selected from Al, Cr, Mo, Ti, W, Zr, and combinations thereof.

The chelating agent may be selected from polyvinyl alcohols, polyalkylene glycols, poly(meth)acrylic acids, polyvinylbutyral, carboxylic acid, and mixtures thereof.

The drying may be performed at a temperature ranging from about 100 to about 400° C.

The heat treatment may be performed at a temperature ranging from about 800 to about 1200° C. Further, the heat treatment may be performed under a nitrogen atmosphere.

According to yet another embodiment of the present invention, a negative electrode includes the negative active material.

According to another embodiment of the present invention, a rechargeable lithium battery includes a negative electrode including the negative active material, a positive electrode including a positive active material, and an electrolyte.

### BRIEF DESCRIPTION OF THE DRAWINGS

The above and other features of the present invention will become more apparent by reference to the following detailed description when considered in conjunction with the attached drawings, in which:

FIG. 1 is a schematic cross-sectional view of a rechargeable lithium battery according to one embodiment of the present invention;

FIG. 2 is a scanning electron microscope (“SEM”) photograph of a negative active material prepared according to Example 1;

FIG. 3 is a SEM photograph of a negative active material prepared according to Comparative Example 1;

FIG. 4 is a SEM photograph of a negative active material prepared according to Comparative Example 2;

FIG. 5 is a SEM photograph of a negative active material prepared according to Comparative Example 3;

FIG. 6 is a graph depicting the results of X-ray diffraction analysis of a negative active material prepared according to Example 1;

FIG. 7 is a graph depicting the results of X-ray diffraction analysis of a negative active material prepared according to Comparative Example 1;

FIG. 8 is a graph of the results of X-ray diffraction analysis of a negative active material prepared according to Comparative Example 2; and

FIG. 9 is a graph of the results of X-ray diffraction analysis of a negative active material prepared according to Comparative Example 3.

### DETAILED DESCRIPTION OF THE EMBODIMENTS

According to one embodiment of the present invention, a negative active material for a rechargeable lithium battery imparts better battery cycle-life characteristics than a conventional negative active material.

In one embodiment, the negative active material includes secondary particles formed by assembly of primary particles. The primary particles include a compound represented by the following Formula 1.

LiₓM_{y}V_{z}O_{2+d} Chemical Formula 1

In Formula 1, 0.1≦x≦2.5, 0≦y≦0.5, 0.5≦z≦1.5, 0≦d≦0.5, and M is a metal selected from Al, Cr, Mo, Ti, W, Zr, and combinations thereof. According to one embodiment, M is either Mo or W.

In Formula 1, when x, y, z, and d are outside the aforementioned ranges, the negative active material may have a high average potential of greater than 1.0V against a lithium metal, resulting in decreased battery discharge voltage. In particular, metal vanadium oxide (not including Li (i.e., x=0)) negative active materials have different crystalline structures from those of the negative active materials of the present invention. In addition, since the metal vanadium oxides have average discharge potentials of greater than 1.0 V, they may be problematic for use as negative electrodes.

The primary particles can be synthesized, for example, by substituting the Co of LiCoO₂ with another transition element, such as V, and a second metal element, such as Al, Mo, W, Ti, Cr, Zr, or combinations thereof. The synthesized primary particles may have a layered structure.

The primary particles may have an average particle diameter ranging from about 0.1 to about 10 μm. According to one embodiment, the primary particles have an average particle diameter ranging from about 0.1 to about 1 μm. In another embodiment, the primary particles have an average particle diameter ranging from about 1 to about 3 μm. In yet another embodiment, the primary particles have an average particle diameter ranging from about 3 to about 5 μm. In still yet another embodiment, the primary particles have an average particle diameter ranging from about 5 to about 7 μm. In still another embodiment, the primary particles have an average particle diameter ranging from about 7 to about 10 μm. According to one embodiment, the primary particles have an average particle diameter ranging from about 1 to about 5 μm. When the primary particles have an average particle diameter smaller than about 0.1 μm, initial efficiency may be decreased. When the average particle diameter is greater than about 10 μm, capacity may be reduced.

The primary particles are assembled to form secondary particles during the preparation of the active material. The secondary particles may have an average particle diameter ranging from about 2 to about 50 μm. According to one embodiment, the secondary particles have an average particle diameter ranging from about 2 to about 15 μm. In another embodiment, the secondary particles have an average particle diameter ranging from about 15 to about 30 μm. In yet another embodiment, the secondary particles have an average particle diameter ranging from about 30 to about 50 μm. According to another embodiment, the secondary particles have an average particle diameter ranging from about 5 to about 10 μm. In still another embodiment, the secondary particles have an average particle diameter ranging from about 15 to about 20 μm. In still yet another embodiment, the secondary particles have an average particle diameter ranging from about 25 to about 30 μm. When the secondary particles have an average particle diameter smaller than about 2 μm, initial efficiency may be decreased. When the average particle diameter is greater than about 50 μm, capacity may be reduced.

According to one embodiment, a method for making the negative active material having the above structure includes forming a composition by dissolving a vanadium source material, a lithium source material, and a M source material in a solvent. The method further includes adding a chelating agent to the composition to prepare a gel, drying the gel to prepare an organic-inorganic precursor, and subjecting the precursor to heat treatment.

First, a composition for preparing the active material is prepared by dissolving a vanadium source material, a lithium source material, and a metal source material in a solvent.

The vanadium source material may be selected from vanadium metal, VO, V₂O₃, V₂O₄, V₂O₅, V₄O₇, VOSO₄.H₂O, NH₄VO₃, and mixtures thereof.

The lithium source material may be selected from lithium carbonates, lithium hydroxides, lithium nitrates, lithium acetates, and mixtures thereof.

The M source material may be selected from oxides, hydroxides, and mixtures thereof, where M may be selected from Al, Cr, Mo, Ti, W, Zr, and combinations thereof. Nonlimiting examples of the M source material include Al(OH)₃, Al₂O₃, Cr₂O₃, MoO₃, TiO₂, WO₃, and ZrO₂.

The solvent may be selected from distilled water, alcohols, and mixtures thereof.

The mixing ratio of the vanadium source material, lithium source material, and metal source material can be controlled to provide the intended composition ratio of the compound of Formula 1.

A chelating agent is added to the composition for preparing the active material to prepare a gel. The chelating agent imparts uniformity of the medium. Further, the size and shape of the active material particles and surface characteristics can be controlled by adjusting the amount of the chelating agent, the kind of the metal salt, and the temperature and length of heat treatment.

The chelating agent may be an organic polymer material having a hydrophilic side chain. Nonlimiting examples of suitable chelating agents include polyvinyl alcohols, polyalkylene glycols (such as polyethylene glycol and polypropylene glycol), poly(meth)acrylic acids, polyvinylbutyral, carboxylic acids (such as glycine, citric acid, and oxalic acid), and mixtures thereof.

The chelating agent may be added in an amount ranging from about 0.25 to about 10 moles based on 1 mole of total metal ions in the active material composition. According to one embodiment, the chelating agent may be added in an amount ranging from about 0.25 to about 1 mole based on 1 mole of total metal ions in the active material composition. In another embodiment, the chelating agent may be added in an amount ranging from about 1 to about 3 moles based on 1 mole of total metal ions in the active material composition. In yet another embodiment, the chelating agent may be added in an amount ranging from about 3 to about 5 moles based on 1 mole of total metal ions in the active material composition. In still another embodiment, the chelating agent may be added in an amount ranging from about 5 to about 7 moles based on 1 mole of total metal ions in the active material composition. In still yet another embodiment, the chelating agent may be added in an amount ranging from about 7 to about 10 moles based on 1 mole of total metal ions in the active material composition. According to another embodiment, the chelating agent may be added in an amount ranging from about 1 to about 5 moles based on 1 mole of total metal ions in the active material composition. The chelating agent can be dissolved in distilled water to prepare a solution, which is then added to the active material composition. When the amount of the chelating agent is less than about 0.25 moles, the intended material phase change is not adequately effected. When the amount of the chelating agent is greater than about 10 moles, residues remaining after reaction may increase.

The active material composition and the chelating agent solution are mixed and the chelating agent is then chelated to the metal ions. This results in the uniform distribution of the metal ions and the chelating agent in solution.

The resulting mixed solution is heated at a temperature ranging from about 100 to about 400° C. to evaporate water, producing an organic-inorganic precursor in which the metal ions and the chelating agent are bound to each other. According to one embodiment, the mixed solution is heated at a temperature ranging from about 100 to about 200° C. According to another embodiment, the mixed solution is heated at a temperature ranging from about 200 to about 300° C. In yet another embodiment, the mixed solution is heated at a temperature ranging from about 300 to about 400° C. According to still another embodiment, the mixed solution is heated at a temperature ranging from about 150 to about 200° C. In still another embodiment, the mixed solution is heated at a temperature ranging from about 200 to about 250° C. In still yet another embodiment, the mixed solution is heated at a temperature ranging from about 250 to about 300° C. When the heating temperature is lower than about 100° C., drying time may be increased. When the heating temperature is greater than about 400° C., uniformity of the precursor may be decreased.

The above prepared precursor may have an average particle size of sub-microns.

The precursor is then heated to prepare a negative active material for a rechargeable lithium battery. The negative active materials include secondary particles including assemblies of primary particles represented by Formula 1. The heating is performed at a temperature ranging from about 800 to about 1200° C. In one embodiment, the heating is performed at a temperature ranging from about 900 to about 1000° C. When the heating is performed at a temperature lower than about 800° C., crystallinity may be reduced. When heating is performed at a temperature greater than about 1200° C., impurities, including undesired phases, may be produced.

The heating may be performed for from about 3 to about 15 hours. In one embodiment, the heating is performed for from about 5 to about 10 hours. When the heating is performed for less than about 3 hours, the average particle diameter of the active material may be reduced. When heating is performed for more than about 15 hours, the average particle diameter may be excessively large.

The heating may be performed under a nitrogen atmosphere in order to remove impurities, such as undesired phases.

The negative active material for a rechargeable lithium battery prepared according to the above method includes secondary particles including assemblies of primary particles. The active material has good conductivity, and impart good cycle-life and low temperature characteristics. Thus, the active materials improve battery characteristics, such as initial efficiency.

The above negative active material is used for negative electrodes of rechargeable lithium batteries. According to one embodiment of the present invention, a rechargeable lithium battery includes a negative electrode including a negative active material, a positive electrode including a positive active material, and an electrolyte.

Rechargeable lithium batteries may be classified as lithium ion batteries, lithium ion polymer batteries, and lithium polymer batteries according to the presence of a separator and the kind of electrolyte used in the battery. Rechargeable lithium batteries may have a variety of shapes and sizes, including cylindrical, prismatic, or coin-type batteries, and may be thin film batteries or rather bulky in size. Structures and fabricating methods for lithium batteries pertaining to the present invention are well known in the art.

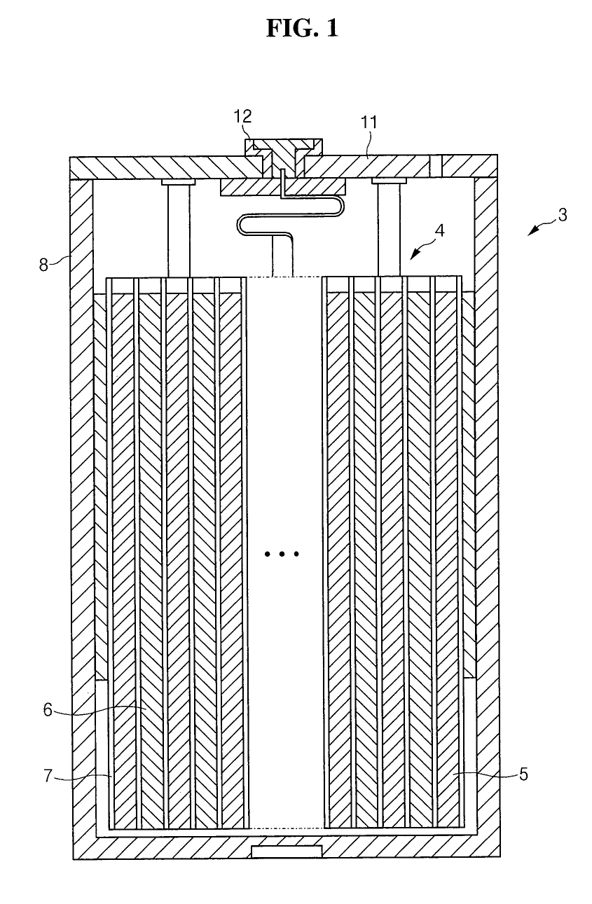

FIG. 1 illustrates an exemplary structure of a rechargeable lithium battery according to one embodiment of the present invention. As shown in FIG. 1, a rechargeable lithium battery 3 includes an electrode assembly 4, which includes a positive electrode 5, a negative electrode 6, and a separator 7 between the positive electrode 5 and the negative electrode 6. The electrode assembly 4 is housed in a battery case 8, which is sealed by a cap plate 11 and a gasket 12. After sealing the battery case, an electrolyte is injected through an opening in the battery case 8 to complete the battery.

The negative electrode includes a negative active material, which may be an above described negative active material or a mixture of first and second negative active materials in which the first negative active material is an above described negative material and the second negative active material is a carbon-based negative active material (such as graphite). The mixture may include the first negative active material and the second negative active material in a weight ratio ranging from about 1:99 to about 99:1. According to one embodiment, the mixture includes the first negative active material and the second negative active material in a weight ratio ranging from about 10:90 to about 90:10.

The negative electrode may be fabricated by mixing the negative active material, a binder, and optionally a conductive agent in a solvent to form a composition, which is then applied on a negative current collector such as copper. The negative electrode manufacturing method is well known.

Nonlimiting examples of suitable binders include polyvinyl alcohol, carboxymethyl cellulose, hydroxypropylene cellulose, diacetylene cellulose, polyvinylchloride, carboxylated polyvinylchloride, polyvinyldifluoride, ethylene oxide-containing polymers, polyvinylpyrrolidone, polyurethane, polytetrafluoroethylene, polyvinylidene fluoride, polyethylene, polypropylene, styrene-butadiene rubbers, acrylated styrene-butadiene rubbers, epoxy resins, and polyamide.

Any electrically conductive material can be used as the conductive agent so long as it does not cause a chemical change. Nonlimiting examples of suitable conductive agents include natural graphite, artificial graphite, carbon black, acetylene black, ketjen black, carbon fiber, polyphenylene derivatives, and metal powders or metal fibers including copper, nickel, aluminum, silver, and so on.

One nonlimiting example of a suitable solvent is N-methyl pyrrolidone.

The current collector may be selected from copper foils, nickel foils, stainless steel foils, titanium foils, nickel foams, copper foams, polymer substrates coated with conductive metals, and combinations thereof.

The positive electrode includes a positive active material, which may be a lithiated intercalation compound capable of reversibly intercalating and deintercalating lithium. Nonlimiting examples of suitable positive active materials include composite oxides including lithium and a metal selected from cobalt, manganese, nickel, and combinations thereof. Nonlimiting examples of suitable composite oxides include the compounds represented by Formulas 2 to 25.

LiₐA_{1-b}B_{b}D₂ Chemical Formula 2

### In Formula 2, 0.95≦a≦1.1, and 0≦b≦0.5.

LiₐE_{1-b}B_{b}O_{2-c}F_{c} Chemical Formula 3

### In Formula 3, 0.95≦a≦1.1, 0≦b≦0.5, and 0≦c≦0.05.

LiE_{2-b}B_{b}O_{4-c}F_{c} Chemical Formula 4

### In Formula 4, 0≦b≦0.5, and 0≦c≦0.05.

LiₐNi_{1-b-c}Co_{b}B_{c}D_{α} Chemical Formula 5

### In Formula 5, 0.95≦a≦1.1, 0≦b≦0.5, 0≦c≦0.05, and 0<α≦2.

LiₐNi_{1-b-c}Co_{b}B_{c}O_{2-α}F_{α} Chemical Formula 6

### In Formula 6, 0.95≦a≦1.1, 0≦b≦0.5, 0≦c≦0.05, and 0<α<2.

LiₐNi_{1-b-c}Co_{b}B_{c}O_{2-α}F_{α} Chemical Formula 7

### In Formula 7, 0.95≦a≦1.1, 0≦b≦0.5, 0≦c≦0.05, and 0<α<2.

LiₐNi_{1-b-c}Mn_{b}B_{c}D_{α} Chemical Formula 8

### In Formula 8, 0.95≦a≦1.1, 0≦b≦0.5, 0≦c≦0.05, and 0<α≦2.

LiₐNi_{1-b-c}Mn_{b}B_{c}O_{2-α}F_{α} Chemical Formula 9

### In Formula 9, 0.95≦a≦1.1, 0≦b≦0.5, 0≦c≦0.05, and 0<α<2.

LiₐNi_{1-b-c}Mn_{b}B_{c}O_{2-α}F₂ Chemical Formula 10

### In Formula 10, 0.95≦a≦1.1, 0≦b≦0.5, 0≦c≦0.05, and 0<α<2.

LiₐNi_{b}E_{c}G_{d}O₂ Chemical Formula 11

### In Formula 11, 0.90≦a≦1.1, 0≦b≦0.9, 0≦c≦0.5, and 0.001≦d≦0.1.

LiₐNi_{b}Co_{c}Mn_{d}GₑO₂ Chemical Formula 12

### In Formula 12, 0.90≦a≦1.1, 0≦b≦0.9, 0≦c≦0.5, 0≦d≦0.5, and 0.001≦e≦0.1.

LiₐNiG_{b}O₂ Chemical Formula 13

### In Formula 13, 0.90≦a≦1.1, and 0.001≦b≦0.1.

LiₐCoG_{b}O₂ Chemical Formula 14

### In Formula 14, 0.90≦a≦1.1, and 0.001≦b≦0.1.

LiₐMnG_{b}O₂ Chemical Formula 15

### In Formula 15, 0.90≦a≦1.1, and 0.001≦b≦0.1.

LiₐMn₂ G_{b}O₄ Chemical Formula 16

### In Formula 16, 0.90≦a≦1.1, and 0.001≦b≦0.1.

QO₂ Chemical Formula 17

QS₂ Chemical Formula 18

LiQS₂ Chemical Formula 19

V₂O₅ Chemical Formula 20

LiV₂O₅ Chemical Formula 21

LilO₂ Chemical Formula 22

LiNiVO₄ Chemical Formula 23

Li_{3-f}J₂(PO₄)₃ Chemical Formula 24

### In Formula 24, 0≦f≦3.

Li_{3-f}Fe₂(PO₄)₃ Chemical Formula 25

### In Formula 25, 0≦f≦2.

In Formulas 2 to 25, A is selected from Ni, Co, Mn, and combinations thereof. B is selected from Al, Ni, Co, Mn, Cr, Fe, Mg, Sr, V, rare earth elements, and combinations thereof. D is selected from O, F, S, P, and combinations thereof. E is selected from Co, Mn, and combinations thereof. F is selected from F, S, P, and combinations thereof. G is selected from Al, Cr, Mn, Fe, Mg, La, Ce, Sr, V, lanthanide elements, and combinations thereof. Q is selected from Ti, Mo, Mn, and combinations thereof. I is selected from Cr, V, Fe, Sc, Y, and combinations thereof. J is selected from V, Cr, Mn, Co, Ni, Cu, and combinations thereof.

The positive active material may be selected from elemental sulfur (S₈), sulfur-based compounds (such as Li₂Sₙ (where n≧1) and Li₂Sₙ (wherein ≧1)) dissolved in a catholyte, organic sulfur compounds, and carbon-sulfur polymers (such as (C₂S_{f})ₙ, where f ranges from 2.5 to 50 and n≧2).

The positive electrode may also include a binder to improve adherence of the positive active material layer to the current collector. The positive active material may also include a conductive material to improve electrical conductivity.

Nonlimiting examples of suitable binders include polyvinyl alcohol, carboxymethyl cellulose, hydroxypropylene cellulose, diacetylene cellulose, polyvinylchloride, carboxylated polyvinylchloride, polyvinyldifluoride, ethylene oxide-containing polymers, polyvinylpyrrolidone, polyurethane, polytetrafluoroethylene, polyvinylidene fluoride, polyethylene, polypropylene, styrene-butadiene rubbers, acrylated styrene-butadiene rubbers, epoxy resins, and polyamide.

Any electrically conductive material can be used as the conductive material so long as it does not cause a chemical change. Nonlimiting examples of suitable conductive materials include natural graphite, artificial graphite, carbon black, acetylene black, ketjen black, carbon fibers, polyphenylene derivatives, metal powders and metal fibers including copper, nickel, aluminum, silver, and so on.

The positive electrode can be fabricated by mixing a positive active material, a binder, and optionally a conductive agent in a solvent to form a composition which is then applied on a positive current collector such as aluminum.

The positive current collector may be selected from aluminum foils, nickel foils, stainless steel foils, titanium foils, nickel foams, aluminum foams, polymer substrates coated with conductive metals, and combinations thereof. According to one embodiment, the positive current collector is an aluminum foil.

In a rechargeable battery according to one embodiment of the present invention, the electrolyte may be a non-aqueous electrolyte or a solid electrolyte.

The non-aqueous electrolyte may include a lithium salt dissolved in a non-aqueous organic solvent. The lithium salt act as a lithium-ion source, helping basic battery operation. Nonlimiting examples of suitable lithium salts include LiPF₆, LiBF₄, LiSbF₆, LiAsF₆, LiClO₄, LiCF₃SO₃, LiC₄F₉SO₃, LiN(CF₃SO₂)₂, LiN(C₂F₅SO₂)₂, LiAlO₂, LiAlCl₄, LiN(CₚF₂ₚ₊₁SO₂)(C_{q}F_{2q+1}SO₂) (wherein p and q are natural numbers), LiCl, Lil, and LiB(C₂O₄)₂. According to one embodiment, the lithium salt is LiBF₄. According to another embodiment, the lithium salt is either LiPF₆ or LiBF₄.

The lithium salt may be present in the electrolyte in a concentration ranging from about 0.6 to about 2.0M. According to one embodiment, the lithium salt is present in a concentration ranging from about 0.7 to about 1.6 M. When the lithium salt concentration is below about 0.6M, electrolyte performance may deteriorate due to low electrolyte conductivity. When the lithium salt concentration is greater than about 2.0M, lithium ion mobility may decrease due to increased electrolyte viscosity.

The non-aqueous organic solvent acts as a medium for transmitting the ions taking part in the electrochemical reaction of the battery. The non-aqueous organic solvent may include a carbonate-based, ester-based, ether-based, ketone-based, alcohol-based, or aprotic solvent. Nonlimiting examples of suitable carbonate-based solvents include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate (EMC), ethylene carbonate (EC), propylene carbonate (PC), butylene carbonate (BC), and so on. Nonlimiting examples of suitable ester-based solvents include n-methyl acetate, n-ethyl acetate, n-propyl acetate, dimethylacetate, methylpropionate, ethylpropionate, γ-butyrolactone, decanolide, valerolactone, mevalonolactone, caprolactone, and so on. Nonlimiting examples of suitable ether-based solvents include dibutyl ether, tetraglyme, diglyme, dimethoxyethane, 2-methyltetrahydrofuran, tetrahydrofuran, and so on. Nonlimiting examples of suitable ketone-based solvents include cyclohexanone, and so on. Nonlimiting examples of suitable alcohol-based solvents include ethanol, isopropyl alcohol, and so on. Nonlimiting examples of suitable aprotic solvents include nitriles (such as X—CN, where X is a C₂ to C₂₀ linear, branched, or cyclic hydrocarbon, a double bond, an aromatic ring, or an ether bond), amides (such as dimethylformamide), dioxolanes (such as 1,3-dioxolane), sulfolane, and so on.

The non-aqueous organic solvent may be a single solvent or a mixture of solvents. When the organic solvent includes a mixture, the mixture ratio can be controlled according to the desired battery performance.

In one embodiment, a carbonate-based solvent may include a mixture of a cyclic carbonate and a linear carbonate. The cyclic carbonate and the linear carbonate may be mixed together in a volume ratio ranging from about 1:1 to about 1:9. When such a mixture is used as an electrolyte, electrolyte performance may be enhanced. According to one embodiment, the cyclic carbonate and the linear carbonate are mixed together in a volume ratio ranging from about 1:1 to 1:3. In another embodiment, the cyclic carbonate and linear carbonate are mixed in a volume ratio ranging from about 1:3 to about 1:5. In yet another embodiment, the cyclic carbonate and linear carbonate are mixed in a volume ratio ranging from about 1:5 to about 1:7. In still another embodiment, the cyclic carbonate and linear carbonate are mixed in a volume ratio ranging from about 1:7 to about 1:9. According to one embodiment, the cyclic carbonate and linear carbonate are mixed in a volume ratio ranging from about 1:1 to about 1:5.

In addition, the electrolyte according to one embodiment of the present invention may further include mixtures of carbonate-based solvents and aromatic hydrocarbon-based solvents. The carbonate-based solvents and the aromatic hydrocarbon-based solvents may be mixed in a volume ratio ranging from about 1:1 to 30:1. According to one embodiment, the carbonate-based solvents and the aromatic hydrocarbon-based solvents are mixed in a volume ratio ranging from about 1:1 to about 10:1. In another embodiment, the carbonate-based solvent and aromatic hydrocarbon-based solvent are mixed in a volume ratio ranging from about 10:1 to about 20:1. In yet another embodiment, the carbonate-based solvent and aromatic hydrocarbon-based solvent are mixed in a volume ratio ranging from about 20:1 to about 30:1. According to one embodiment, the carbonate-based solvent and the aromatic hydrocarbon-based solvent are mixed in a volume ratio ranging from about 1:1 to about 5:1, or from about 5:1 to about 10:1.

The aromatic hydrocarbon-based organic solvent may be represented by Formula 26.

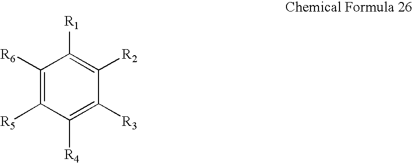

### In Formula 26, each of R₁ through R₆ is independently selected from hydrogen, halogens, C1 to C10 alkyls, haloalkyls, and combinations thereof.

Nonlimiting examples of suitable aromatic hydrocarbon-based organic solvents include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and combinations thereof.

The non-aqueous electrolyte may further include at least one overcharge inhibition additive selected from vinylene carbonate, divinylsulfone, ethylene sulfite, thioacetic acid phenylester compounds (such as thioacetic acid S-phenyl ester and thioacetic acid O-phenyl ester), chroman-based compounds (such as 6-fluoro-chroman), and carbonate-based compounds having a substituent selected from halogens, cyano (CN) groups and nitro (NO₂) groups. The additive imparts improved safety when batteries are stored at high temperatures. This results in improvements in the electrochemical characteristics of batteries such as swelling inhibition, capacity, cycle-life, and low temperature characteristics. In one embodiment, the additive is a carbonate-based compound According to one embodiment, the additive is an ethylene carbonate additive represented by Formula 27 below. According to another embodiment, the additive is fluoroethylene carbonate.

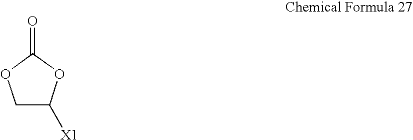

### In Formula 27, X1 is selected from halogens, cyano (CN) groups and nitro (NO₂) groups.

The overcharge inhibition additive can be added in an amount ranging from about 0.1 to about 10 wt % based on the total weight of the electrolyte. According to one embodiment, the overcharge inhibition additive can be added in an amount ranging from about 0.1 to about 1 wt % based on the total weight of the electrolyte. In another embodiment, the overcharge inhibition additive can be added in an amount ranging from about 1 to about 5 wt % based on the total weight of the electrolyte. In yet another embodiment, the overcharge inhibition additive can be added in an amount ranging from about 5 to about 10 wt % based on the total weight of the electrolyte. According to one embodiment, the overcharge inhibition additive can be added in an amount ranging from about 3 to about 5 wt % based on the total weight of the electrolyte. When the amount of the overcharge inhibition additive is less than about 0.1 wt %, the effect of the additive is negligible. When the amount of the additive is greater than 10 wt %, cycle-life problems may occur on charge and discharge.

The solid electrolyte may be a polymer electrolyte including polyethylene oxide. Alternatively, the polymer electrolyte may include at least one polyorganosiloxane side chain or polyoxyalkylene side chain. In another embodiment, the polymer electrolyte may be a sulfide electrolyte (such as Li₂S—SiS₂, Li₂S—GeS₂, Li₂S—P₂S₅, Li₂S—B₂S₃, and the like). In yet another embodiment, the polymer electrolyte may be an inorganic compound electrolyte (such as Li₂S—SiS₂—Li₃PO₄, Li₂S—SiS₂—Li₃SO₄, and the like).

The rechargeable lithium battery generally also includes a separator between the positive electrode and the negative electrode. The separator may include polyethylene, polypropylene, polyvinylidene fluoride, and multi-layers thereof, such as a polyethylene/polypropylene double-layered separator, a polyethylene/polypropylene/polyethylene triple-layered separator, and a polypropylene/polyethylene/polypropylene triple-layered separator.

The following examples illustrate certain aspects of the present invention. These examples, however, are presented for illustrative purposes only and are not to be interpreted as limiting the scope of the present invention.

### Example 1

### Preparation of a Negative Active Material

V₂O₅, Li₂CO₃, and MoO₃ were weighed to obtain a ratio of Li:V:Mo of 1.08:0.9:0.02. These materials were then dispersed in distilled water to prepare an active material composition. The metal salts were completely dissolved to produce an orange solution. Subsequently, a chelating agent solution was prepared by adding a polyvinyl alcohol chelating agent in a molar amount twice that of the total metal ions.

The metal salt solution and the chelating agent solution were mixed and then heated at 200° C. to evaporate water and obtain a precursor. The precursor was heated at 1000° C. for 12 hours under a nitrogen atmosphere to prepare a negative active material for a rechargeable lithium battery. The negative active material included primary particles having an average particle diameter of 5 μm and secondary particles having an average particle diameter of 20 μm.

### Comparative Example 1

### Preparation of a Negative Active Material

V₂O₅, Li₂CO₃, and MoO₃ were mixed in a solid-phase to ratio of Li:V:Mo of 1:0.95:0.05. The mixture was heated at 1000° C. for 10 hours under a nitrogen atmosphere followed by cooling to room temperature. The resulting product was sieved to obtain a negative active material having an average particle diameter of 30 μm.

### Comparative Example 2

### Preparation of a Negative Active Material

V₂O₅, Li₂CO₃, and MoO₃ were weighed to achieve a ratio of Li:V:Mo of 1.08:0.9:0.02. These materials were dispersed in distilled water to prepare an active material composition. The metal salts were completely dissolved to produce an orange solution. Subsequently, a chelating agent solution was prepared by adding a polyvinyl alcohol chelating agent in a molar amount 0.1 times that of the total metal ions.

The metal salt solution and the chelating agent solution were mixed and then heated at 200° C. to evaporate water and obtain a precursor. The precursor was heated at 1000° C. for 12 hours under a nitrogen atmosphere to prepare a negative active material for a rechargeable lithium battery having an average particle diameter of 50 μm.

### Comparative Example 3

### Preparation of a Negative Active Material

V₂O₅, Li₂CO₃, and MoO₃ were weighed to achieve a ratio of Li:V:Mo of 1.08:0.9:0.02. These materials were dispersed in distilled water to prepare an active material composition. The metal salts were completely dissolved to produce an orange solution. Subsequently, a chelating agent solution was prepared by adding a polyvinyl alcohol chelating agent in a molar amount twice that of the total metal ions.

The metal salt solution and the chelating agent solution were mixed and then heated at 200° C. to evaporate water and obtain a precursor. The resulting precursor was heated at 500° C. for 12 hours under a nitrogen atmosphere to obtain a negative active material for a rechargeable lithium battery having an average particle diameter of 40 μm.

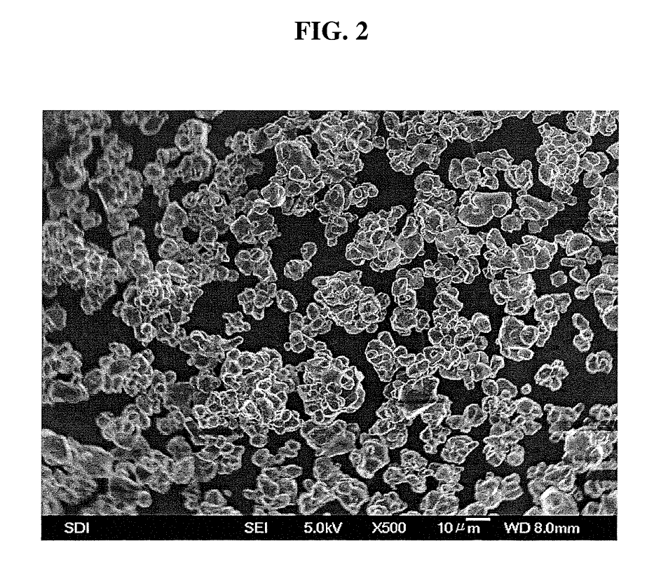

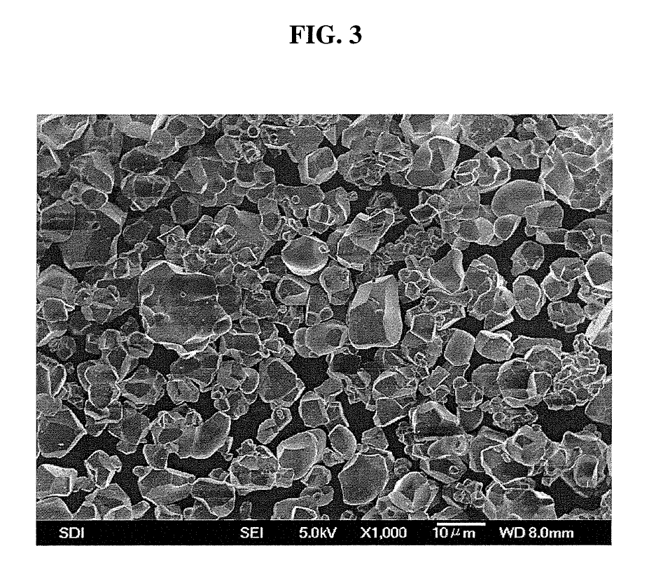

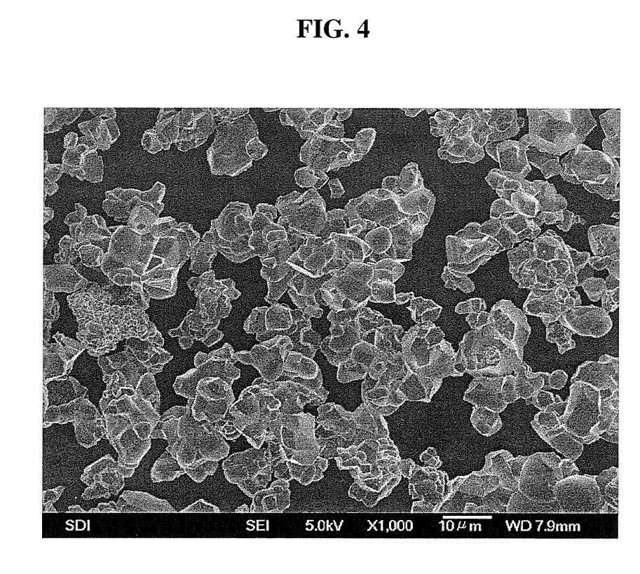

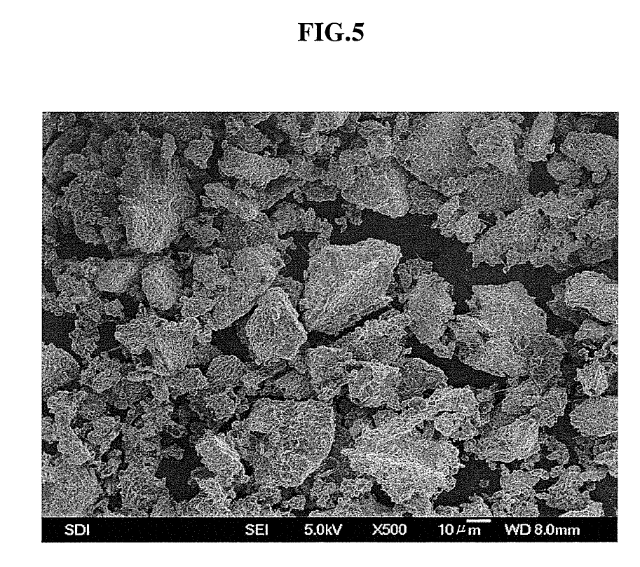

Scanning electron microscope (“SEM”)photographs of the negative active materials according to Example 1 and Comparative Examples 1 to 3 are shown in FIGS. 2 through 5, respectively. Specifically, FIG. 2 is a SEM photograph of the negative active material prepared according to Example 1, FIG. 3 is a SEM photograph of the negative active material prepared according to Comparative Example 1, FIG. 4 is a SEM photograph of the negative active material prepared according to Comparative Example 2, and FIG. 5 is a SEM photograph of the negative active material prepared according to Comparative Example 3.

As shown in FIG. 2, the active material prepared according to Example 1 includes secondary particles including assemblies of primary particles. On the contrary, the active materials prepared according to Comparative Examples 1 through 3 include only primary particles.

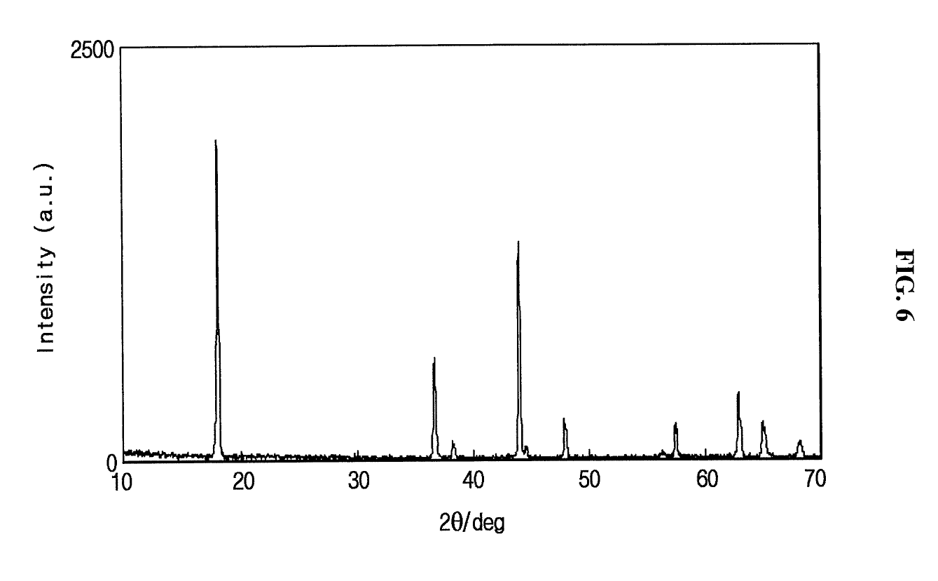

The structures of the negative active materials according to Example 1 and Comparative Examples 1-3 were analyzed using X-ray diffraction. The results are shown in FIGS. 6 through 9. The X-ray diffraction analysis was performed using a CuK a X-ray (1.5418 Å, 40 kV/30 mA) at a scanning rate of 0.02°/second within a 2θ range of 10-80°.

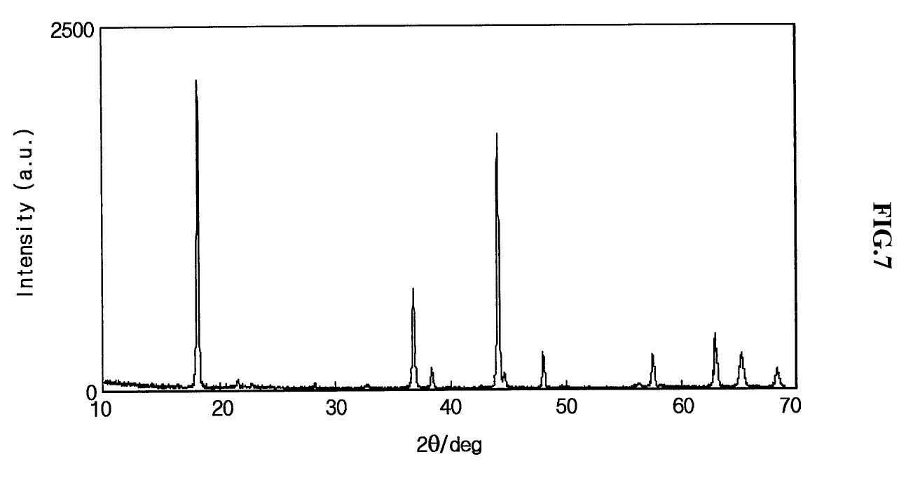

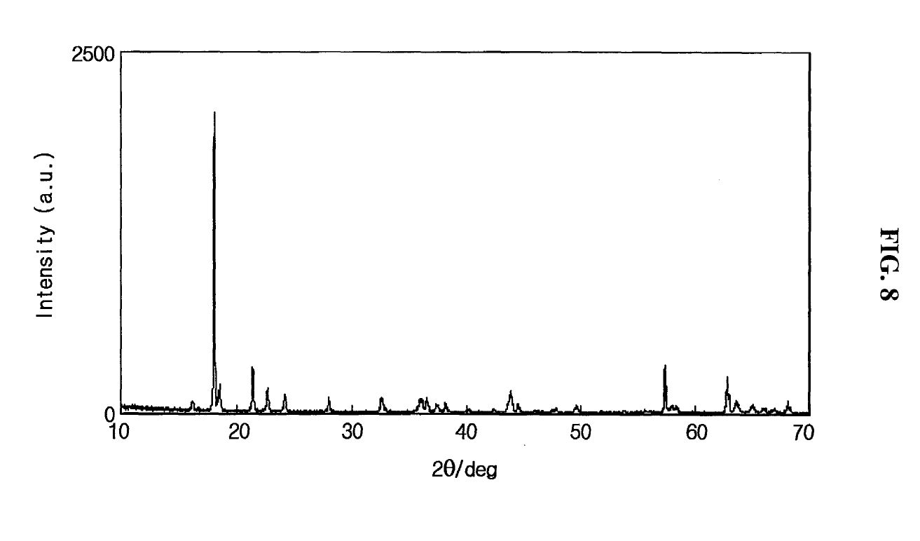

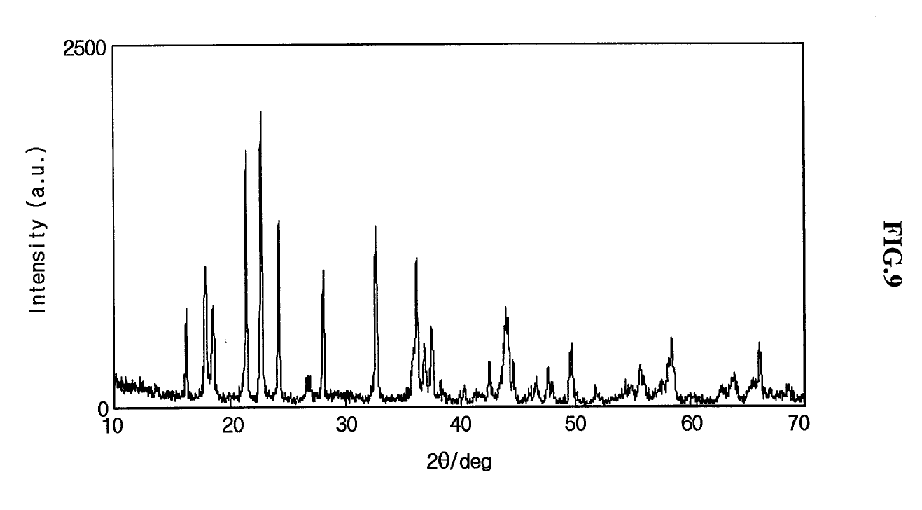

FIG. 6 shows the results of the X-ray diffraction analysis of the negative active materials prepared according to Example 1. FIG. 7 shows the results of the X-ray diffraction analysis of the negative active materials prepared according to Comparative Example 1. FIG. 8 shows the results of the X-ray diffraction analysis of the negative active materials prepared according to Comparative Example 2. FIG. 9 shows the results of the X-ray diffraction analysis of the negative active materials prepared according to Comparative Example 3. As shown in FIGS. 6 through 9, the active materials prepared according to Example 1 showed (003) plane peaks at 20 value of 18 degrees. These results indicate that the active materials prepared according to Example 1 have a layered structure.

### Fabrication of a Test Cell

The negative active materials prepared according to Example 1 and Comparative Examples 1 through 3 were each mixed with graphite to a ratio of 3/7. The resulting mixtures were mixed with polyvinylidene fluoride to a ratio of 96:4 in N-methyl pyrrolidone to prepare negative electrode slurries.

Each negative electrode slurry was coated on copper foil to a thickness of 80 μm, dried at 135° C. for 3 hours or more, and then compressed to fabricate a 45 μm-thick negative electrode.

2016 coin-type half cells were prepared using the negative electrodes as working electrodes, lithium metal foil as the counter electrodes, and porous polypropylene film as the separators between the working electrodes and counter electrodes. 1 mol/L LiPF₆ dissolved in a mixed solvent of propylene carbonate (PC), diethyl carbonate (DEC), and ethylene carbonate (EC) was used as the electrolyte.

The electrical characteristics of the cells including the active materials prepared according to Example 1 and Comparative Examples 1 through 3 were evaluated.

Each cell was charged and discharged within a voltage of 0.01 to 2.0 V at a constant current of 0.2 C for one charge and discharge cycle. Each cell was then charged within a voltage of 0.01 to 1.0 V at a constant current of 0.2 C for one charge and discharge cycle. Each cell was then charged within a voltage of 0.01 to 1.0 V at a constant current of 1 C for 50 charge and discharge cycles. Initial capacity, initial efficiency, and cycle-life characteristics were measured. The measurement results are reported in Table 1 below. The cycle-life characteristics are reported as percent ratios obtained by dividing the 50th discharge capacity by the initial discharge capacity.

TABLE 1

| | Initial | Initial | | |
|---|---|---|---|---|
| | Charge | Discharge | Initial | Cycle-life |
| | Capacity | Capacity | Efficiency | (50th/1^{st}) |
| | [mAh/g] | [mAh/g] | [%] | [%] |
| Example 1 | 335 | 305 | 92 | 85 |
| Comparative | 330 | 283 | 86 | 65 |
| Example 1 | | | | |
| Comparative | 288 | 230 | 80 | 42 |
| Example 2 | | | | |
| Comparative | 318 | 227 | 71 | 25 |
| Example 3 | | | | |

As shown in Table 1,the cells including the negative active materials prepared according to Example 1 showed improved initial capacity and efficiency, as well as improved charge and discharge efficiency and cycle-life characteristics compared to those prepared according to Comparative Examples 1 through 3.

### Example 2

A negative electrode slurry was prepared by mixing the negative active material prepared according to Example 1 with a solution of polytetrafluoroethylene dissolved in N-methylpyrrolidone. The negative electrode slurry was coated on a 14 μm-thick copper foil using a doctor blade, dried at 120° C. for 24 hours under a vacuum atmosphere to evaporate the N-methyl-pyrrolidone, and then compressed to fabricate a negative electrode.

A lithium manganese oxide (LiMn₂O₄) positive active material and natural graphite as a conductive agent were mixed to form a mixture. A polyvinylidene fluoride binder was dissolved in an N-methylpyrrolidone solvent to prepare a binder solution. The mixture was added to the binder solution to fabricate a positive electrode slurry. The positive electrode slurry was coated on a 20 μm-thick aluminum foil using a doctor blade, dried at 120° C. for 24 hours under a vacuum atmosphere to evaporate the N-methyl pyrrolidone, and then compressed to fabricate a positive electrode.

The fabricated electrodes and a 25 μm-thick polyethylene/polypropylene double-layered separator were spiral-wound and compressed. An electrolyte solution was then injected to fabricate a 18650 cylindrical battery cell. 1 mol/L LiPF₆ dissolved in a mixed solvent of propylene carbonate (PC), diethyl carbonate (DEC), and ethylene carbonate (EC) was used as the electrolyte.

### Example 3

A negative active material was prepared as in Example 1 except that instead of MoO₃, Al₂O₃ was used in an amount sufficient to obtain a ratio of Li:V:AI of 1.1:0.97:0.03. Polyethylene glycol was used as the chelating agent in a molar amount might 0.25 times that of the total metal ions. The prepared negative active material included primary particles having an average particle diameter of 0.1 um, and secondary particles having an average particle diameter of 2 μm.

The negative active material was mixed with polytetrafluoroethylene dissolved in N-methylpyrrolidone to prepare a negative electrode slurry. The negative electrode slurry was coated on a 14 μm-thick copper foil using a doctor blade, dried at 120° C. for 24 hours under a vacuum atmosphere to evaporate the N-methylpyrrolidone, and then compressed to fabricate a negative electrode.

A lithium manganese oxide (LiMn₂O₄) positive active material and natural graphite as a conductive agent were mixed to form a mixture. A polyvinylidene fluoride binder was dissolved in an N-methylpyrrolidone solvent to prepare a binder solution. The mixture was added to the binder solution to fabricate a positive electrode slurry. The positive electrode slurry was coated on a 20 μm-thick aluminum foil using a doctor blade, dried at 120° C. for 24 hours under a vacuum atmosphere to evaporate the N-methyl pyrrolidone, and then compressed to fabricate a positive electrode.

The fabricated electrodes and a 25 μm-thick polyethylene/polypropylene double-layered separator were spiral-wound and compressed. An electrolyte solution was then injected to fabricate a 18650 cylindrical battery cell. 0.6M LiN(C₂F₅SO₂)₂ and 1 wt % of nitrocarbonate dissolved in a mixed solvent of propylene carbonate/ethylpropyl carbonate (in a volume ratio of 1:1) and xylene in a volume ratio of 1:1 was used as the electrolyte.

### Example 4

A negative active material was prepared as in Example 1 except that instead of MoO₃, Cr₂O₃ was used in an amount sufficient to obtain a ratio of Li:V:Cr of 1.12:0.85:0.05. Poly(meth)acrylic acid was used as a chelating agent in a molar amount 10 times that of the total metal ions. The prepared negative active material included primary particles having an average particle diameter of 10 μm, and secondary particles having an average particle diameter of 50 μm.

The negative active material was mixed with polyvinylidene fluoride dissolved in N-methylpyrrolidone to prepare a negative electrode slurry. The negative electrode slurry was coated on a 14 μm-thick copper foil using a doctor blade, dried at 120° C. for 24 hours under a vacuum atmosphere to evaporate the N-methylpyrrolidone, and then compressed to fabricate a negative electrode.

A LiNi_{0.9}Co_{0.1}Sr_{0.002}O₂ positive active material and carbon fiber as a conductive agent were mixed to form a mixture. A polyvinylidene fluoride binder was dissolved in an N-methylpyrrolidone solvent to prepare a binder solution. The mixture was added to the binder solution to fabricate a positive electrode slurry. The positive electrode slurry was coated on a 20 μm-thick aluminum foil using a doctor blade, dried at 120° C. for 24 hours under a vacuum atmosphere to evaporate the N-methyl pyrrolidone, and then compressed to fabricate a positive electrode

The fabricated electrodes and a 25 μm-thick polyethylene/polypropylene double-layered separator were spiral-wound and compressed. An electrolyte solution was then injected to fabricate a 18650 cylindrical battery cell. 2.0M LiBF₄ and 10 wt % of divinylsulfone dissolved in a mixed solvent of butylene carbonate/ethylpropyl carbonate (in a volume ratio of 1:9) and 1,3-diiodobenzene in a volume ratio of 30:1 was used as the electrolyte.

### Example 5

A negative active material was prepared as in Example I except that instead of MoO₃, TiO₂ was used in an amount sufficient to obtain a ratio of Li:V:Ti of 1.1:0.89:0.01. Polyvinylbutyral was used as a chelating agent in a molar amount equal to that of the total metal ions. The prepared negative active material included primary particles having an average particle diameter of 0.5 μm, and secondary particles having an average particle diameter of 15 μm.

The negative active material was mixed with polyvinylidene fluoride dissolved in N-methylpyrrolidone to prepare a negative electrode slurry. The negative electrode slurry was coated on a 14 μm-thick copper foil using a doctor blade, dried at 120° C. for 24 hours under a vacuum atmosphere to evaporate the N-methylpyrrolidone, and then compressed to fabricate a negative electrode.

A LiMn₂O₄ positive active material and carbon black as a conductive agent were mixed to form a mixture. A polyvinylidene fluoride binder was dissolved in an N-methylpyrrolidone solvent to prepare a binder solution. The mixture was added to the binder solution to fabricate a positive electrode slurry. The positive electrode slurry was coated on a 20 μm-thick aluminum foil using a doctor blade, dried at 120° C. for 24 hours under a vacuum atmosphere to evaporate the N-methylpyrrolidone, and then compressed to fabricate a positive electrode.

The fabricated electrodes and a 25 um-thick polyethylene separator were spiral-wound and compressed. An electrolyte solution was then injected to fabricate a 18650 cylindrical battery cell. 0.7M LiCF₃SO₃ and 5 wt % of thioacetic acid S-phenyl ester dissolved in a mixed solvent of ethylene carbonate/dimethyl carbonate (in a volume ratio of 1:3) and fluorobenzene in a volume ratio of 10:1 was used as the electrolyte.

### Example 6

A negative active material was prepared as in Example 1 except that instead of MoO₃, WO₃ was used in an amount sufficient to obtain a ratio of Li:V:W of 1.05:0.88:0.02. Glycine was used as a chelating agent in a molar amount 5 times that of the total metal ions. The prepared negative active material included primary particles having an average particle diameter of 2 μm, and secondary particles having an average particle diameter of 20 μm.

The negative active material was mixed with polyvinylidene fluoride dissolved in N-methylpyrrolidone to prepare a negative electrode slurry. The negative electrode slurry was coated on a 14 μm-thick copper foil using a doctor blade, dried at 120° C. for 24 hours under a vacuum atmosphere to evaporate the N-methylpyrrolidone, and then compressed to fabricate a negative electrode.

A LiMn₂O₄ positive active material and copper powder as a conductive agent were mixed to form a mixture. A polyvinylidene fluoride binder was dissolved in an N-methylpyrrolidone solvent to prepare a binder solution. The mixture was added to the binder solution to fabricate a positive electrode slurry. The positive electrode slurry was coated on a 20 um-thick aluminum foil using a doctor blade, dried at 120° C. for 24 hours under a vacuum atmosphere to evaporate the N-methylpyrrolidone, and then compressed to fabricate a positive electrode

The fabricated electrodes and a 25 μm-thick polyethylene separator were spiral-wound and compressed. An electrolyte solution was then injected to fabricate a 18650 cylindrical battery cell. 1.6M LiPF₆ and 2 wt % of ethylene sulfite dissolved in a mixed non-aqueous organic solvent of ethylene carbonate/dimethyl carbonate (in a volume ratio of 1:5) and xylene in a volume ratio of 20:1 was used as the electrolyte.

### Example 7

A negative active material was prepared as in Example 1 except that instead of MoO₃, ZrO₂ was used in an amount sufficient to obtain a ratio of Li:V:Zr of 1.1:0.9:0.03. Polyvinyl alcohol was used as a chelating agent in a molar amount twice that of the total metal ions. The prepared negative active material included primary particles having an average particle diameter of 4 μm, and secondary particles having an average particle diameter of 30 μm.

The negative active material was mixed with polyvinylidene fluoride dissolved in N-methylpyrrolidone to prepare a negative electrode slurry. The negative electrode slurry was coated on a 14 μm-thick copper foil using a doctor blade, dried at 120° C. for 24 hours under a vacuum atmosphere to evaporate the N-methylpyrrolidone, and then compressed to fabricate a negative electrode.

A LiMn₂O₄ positive active material and acetylene black as a conductive agent were mixed to form a mixture. A polyvinylidene fluoride binder was dissolved in an N-methylpyrrolidone solvent to prepare a binder solution. The mixture was added to the binder solution to fabricate a positive electrode slurry. The positive electrode slurry was coated on a 20 μm-thick aluminum foil using a doctor blade, dried at 120° C. for 24 hours under a vacuum atmosphere to evaporate the N-methylpyrrolidone, and then compressed to fabricate a positive electrode

The fabricated electrodes and a 25 μm-thick polyethylene separator were spiral-wound and compressed. An electrolyte solution was then injected to fabricate a 18650 cylindrical battery cell. 1.0M LiPF₆ and 8 wt % of 6-fluoro-chroman dissolved in a non-aqueous organic mixed solvent of ethylene carbonate/dimethyl carbonate (in a volume ratio of 1:7) and fluorobenzene in a volume ratio of 15:1 was used as the electrolyte.

### Example 8

A negative active material was prepared as in Example 1 except that instead of MoO₃, both TiO₂ and MoO₃ were used in amounts sufficient to obtain a ratio of Li:V:Ti:Mo of 1.1:0.84:0.03:0.03. Polyvinyl alcohol was used as a chelating agent in a molar amount twice that of the total metal ions. The prepared negative active material included primary particles having an average particle diameter of 6 μm, and secondary particles having an average particle diameter of 40 μm.

The negative active material was mixed with polyvinylidene fluoride dissolved in N-methylpyrrolidone to prepare a negative electrode slurry. The negative electrode slurry was coated on a 14 μm-thick copper foil using a doctor blade, dried at 120° C. for 24 hours under a vacuum atmosphere to evaporate the N-methylpyrrolidone, and then compressed to fabricate a negative electrode.

A LiMn₂O₄ positive active material and artificial graphite as a conductive agent were mixed to form a mixture. A polyvinylidene fluoride binder was dissolved in a N-methylpyrrolidone solvent to prepare a binder solution. The mixture was added to the binder solution to fabricate a positive electrode slurry. The positive electrode slurry was coated on a 20 μm-thick aluminum foil using a doctor blade, dried at 120° C. for 24 hours under a vacuum atmosphere to evaporate the N-methylpyrrolidone, and then compressed to fabricate a positive electrode.

The fabricated electrodes and a 25 μm-thick polyethylene separator were spiral-wound and compressed. An electrolyte solution was then injected to fabricate a 18650 cylindrical battery cell. 1.5M LiPF₆ and 4 wt % of vinylene carbonate dissolved in a mixed non-aqueous organic solvent of ethylene carbonate/dimethyl carbonate (in a volume ratio of 1:5) and fluorobenzene in a volume ratio of 25:1 was used as the electrolyte.

### Comparative Example 4

V₂O₅, Li₂CO₃, and MoO₃ were weighed to obtain a ratio of Li:V:Mo of 1.08:0.9:0.02. These materials were then dispersed in distilled water to prepare an active material composition. The metal salts were completely dissolved to produce an orange solution. Subsequently, a chelating agent solution was prepared using polyvinyl alcohol as a chelating agent in a molar amount of 0.1 moles based on 1 mole of the total metal ions.

The metal salt solution and chelating agent solution were mixed and then heated at 200° C. to evaporate water and obtain a precursor. The precursor was heated at 600° C. for 12 hours under a nitrogen atmosphere to obtain a negative active material for a rechargeable lithium battery. The prepared negative active material included primary particles having an average particle diameter of 0.05 μm, and secondary particles having an average particle diameter of 1 μm.

A rechargeable lithium battery cell was fabricated as in Example 2 using the negative active materials prepared according to Comparative Example 4.

### Comparative Example 5

V₂O₅, Li₂CO₃, and MoO₃ were weighed to obtain a ratio of Li:V:Mo of 1.08:0.9:0.02. These materials were then dispersed in distilled water to prepare an active material composition. The metal salts were completely dissolved to produce an orange solution. Subsequently, a chelating agent solution was prepared using polyvinyl alcohol as a chelating agent in a molar amount of 12 moles based on 1 mole of the total metal ions.

The metal salt solution and chelating agent solution were mixed and then heated at 200° C. to evaporate water and obtain a precursor. The precursor was heated at 1000° C. for 12 hours under a nitrogen atmosphere to prepare a negative active material for a rechargeable lithium battery. The prepared negative active material included primary particles having an average particle diameter of 2.5 μm, and secondary particles having an average particle diameter of 55 μm.

A rechargeable lithium battery cell was fabricated as in Example 2 using the negative active material prepared according to Comparative Example 5.

The cycle-life characteristics of the cells prepared according to Examples 2 through 8 and Comparative Examples 4 and 5 were evaluated. The cycle-life evaluation was performed as described above with respect to Example 1 and Comparative Examples 1 through 3. The measurement results are reported in Table 2 below. The cycle-life characteristics are reported as percent ratios obtained by dividing the 50th discharge capacity by the initial discharge capacity.

TABLE 2

| | Initial | Initial | | |
|---|---|---|---|---|
| | Charge | Discharge | Initial | Cycle-life |
| | Capacity | Capacity | Efficiency | (50th/1^{st}) |
| | [mAh/g] | [mAh/g] | [%] | [%] |
| Example 2 | 345 | 307 | 89 | 91 |
| Example 3 | 338 | 306 | 91 | 88 |
| Example 4 | 348 | 312 | 90 | 86 |
| Example 5 | 351 | 315 | 90 | 90 |
| Example 6 | 335 | 303 | 90 | 87 |
| Example 7 | 341 | 300 | 88 | 83 |
| Example 8 | 336 | 301 | 90 | 84 |
| Comparative | 302 | 252 | 83 | 38 |
| Example 4 | | | | |
| Comparative | 311 | 246 | 79 | 41 |
| Example 5 | | | | |

As shown in Table 2, the cells prepared according to Examples 2 through 8 showed significantly better battery characteristics than those according to Comparative Examples 4 and 5 (which included active materials with particle diameters outside the ranges of the present invention).

The negative active materials for rechargeable lithium batteries according to the present invention provide rechargeable lithium batteries having excellent cycle-life characteristics.

While this invention has been illustrated and described in connection with certain exemplary embodiments, it is understood by those of ordinary skill in the art that various modifications and changes may be made to the described embodiments without departing from the spirit and scope of the present invention, as defined in the appended claims.

What is claimed is:

1. A negative active material for a rechargeable lithium battery comprising:
secondary particles comprising assemblies of primary particles, wherein the primary particles comprise a compound represented by Formula 1:
LiₓM_{y}V_{z}O_{2+d}, Chemical Formula 1
wherein, 0.1≦x≦2.5, 0≦y≦0.5, 0.5≦z≦1.5, 0≦d≦0.5, and M is a metal selected from the group consisting of Al, Cr, Mo, Ti, W, Zr, and combinations thereof.

2. The negative active material of claim 1, wherein M is selected from the group consisting of Mo and W.

3. The negative active material of claim 1, wherein the primary particles have an average particle diameter ranging from about 0.1 to about 10 μm.

4. The negative active material of claim 1, wherein the primary particles have a layered structure.

5. The negative active material of claim 1, wherein the secondary particles have an average particle diameter ranging from about 2 to about 50 μm.

6. A method of preparing a negative active material for a rechargeable lithium battery comprising:
dissolving a vanadium source material, a lithium source material, and a M source material in a solvent to form a composition, wherein M is selected from the group consisting of Al, Cr, Mo, Ti, W, Zr, and combinations thereof;
adding a chelating agent to the composition to prepare a gel;
drying the gel to prepare an organic-inorganic precursor; and
subjecting the organic-inorganic precursor to heat treatment.

7. The method of claim 6, wherein the vanadium source material is selected from the group consisting of vanadium metal, VO, V₂O₃, V₂O₄, V₂O₅, V₄O₇, VOSO₄.H₂O, NH₄VO₃, and mixtures thereof.

8. The method of claim 6, wherein the lithium source material is selected from the group consisting of lithium carbonates, lithium hydroxides, lithium nitrates, lithium acetates, and mixtures thereof.

9. The method of claim 6, wherein the M source material is selected from the group consisting of M-containing oxides, M-containing hydroxides, and mixtures thereof.

10. The method of claim 6, wherein the chelating agent is selected from the group consisting of polyvinyl alcohol, polyalkylene glycols, poly(meth)acrylic acids, polyvinylbutyral, carboxylic acid, and mixtures thereof.

11. The method of claim 6, wherein the drying is performed at a temperature ranging from about 100 to about 400° C.

12. The method of claim 6, wherein the heat treatment is performed at a temperature ranging from about 800 to about 1200° C.

13. The method of claim 6, wherein the heat treatment is performed under a nitrogen atmosphere.

14. A negative electrode for a rechargeable lithium battery comprising:
a negative active material comprising:
secondary particles comprising assemblies of primary particles, wherein the primary particles comprise a compound represented by Formula 1:
LiₓM_{y}V_{z}O_{2+d} Formula 1
wherein, 0.1≦x≦2.5, 0≦y≦0.5, 0.5≦z≦1.5, 0≦d≦0.5, and M is a metal selected from the group consisting of Al, Cr, Mo, Ti, W, Zr, and combinations thereof.

15. The negative electrode of claim 14, wherein M is selected from the group consisting of Mo and W.

16. The negative electrode of claim 14, wherein the primary particles have an average particle diameter ranging from about 0.1 to about 10 μm.

17. The negative electrode of claim 14, wherein the primary particles have a layered structure.

18. The negative electrode of claim 14, wherein the secondary particles have an average particle diameter ranging from about 2 to about 50 μm.

19. A rechargeable lithium battery comprising:
a negative electrode comprising a negative active material comprising:
secondary particles comprising assemblies of primary particles, wherein the primary particles comprise a compound represented by Formula 1:
LiₓM_{y}V_{z}O_{2+d} Formula 1
wherein, 0.1≦x≦2.5, 0≦y≦0.5, 0.5≦z≦1.5, 0≦d≦0.5, and M is a metal selected from the group consisting of Al, Cr, Mo, Ti, W, Zr, and combinations thereof;
a positive electrode including a positive active material capable of intercalating and deintercalating lithium ions; and
an electrolyte.

20. The rechargeable lithium battery of claim 19, wherein M is selected from the group consisting of Mo and W.

21. The rechargeable lithium battery of claim 19, wherein the primary particles have an average particle diameter ranging from about 0.1 to about 10 μm.

22. The rechargeable lithium battery of claim 19, wherein the primary particles have a layered structure.

23. The rechargeable lithium battery of claim 19, wherein the secondary particles have an average particle diameter ranging from about 2 to about 50 μm.
